(19) United States
(12) Patent Application Publication
(10) Pub. No.: US 2022/0300774 A1
(43) Pub. Date: Sep. 22, 2022

(54) METHODS, APPARATUSES, DEVICES AND STORAGE MEDIA FOR DETECTING CORRELATED OBJECTS INVOLVED IN IMAGE

(71) Applicant: SENSETIME INTERNATIONAL PTE. LTD., Singapore (SG)

(72) Inventors: Chunya Liu, Singapore (SG); Xuesen Zhang, Singapore (SG); Bairun Wang, Singapore (SG); Jinghuan Chen, Singapore (SG)

(21) Appl. No.: 17/364,582

(22) Filed: Jun. 30, 2021

Related U.S. Application Data
(63) Continuation of application No. PCT/IB2021/054953, filed on Jun. 7, 2021.

(30) Foreign Application Priority Data
Mar. 17, 2021 (SG) 10202102716Y

(51) Int. Cl. G06K 9/64; G06K 9/00; G06K 9/62

(52) U.S. Cl. CPC G06K 9/64; G06K 9/00228; G06K 9/00375; G06K 9/6256

(57) ABSTRACT

The present disclosure provides methods, apparatuses, devices and storage media for detecting correlated objects involved in image. The method can include: detecting a face object, a hand object and a preset body part object involved in a target image, wherein the preset body part object represents a preset connection part between a face and a hand;

respectively predicting correlation between the detected face object and the detected preset body part object, and correlation between the detected preset body part object and the detected hand object, to obtain a first correlation prediction result between the face object and the preset body part object, and a second correlation prediction result between the preset body part object and the hand object; and determining correlated objects involved in the target image based on the first correlation prediction result and the second correlation prediction result.

### CROSS-REFERENCE TO RELATED APPLICATION

The present application is a continuation of International Application No. PCT/IB2021/054953 filed on Jun. 7, 2021, which claims priority to Singapore Patent Application No. 10202102716Y, filed on Mar. 17, 2021, all of which are incorporated herein by reference in their entirety.

### TECHNICAL FIELD

The present disclosure relates to computer technology, in particular to methods, apparatuses, devices, and storage media for detecting correlated objects involved in an image.

### BACKGROUND

Intelligent video analysis technology can assist people to understand states of objects in physical space and their relationship with each other. In an application scenario of intelligent video analysis, it is expected to recognize an identity of a person corresponding to a body part involved in the video.

The correlation between a body part and a personnel identity can be identified by some intermediate information. The intermediate information can indicate an object that has a relatively definite correlation with respect to both the body part and the personnel identity. For example, face information can be used as biological information to identify a person's identity. When it is expected to confirm an identity of a person to whom the hand detected in the image belongs, it can be determined by the face that is correlated with the hand. Here, the correlated object indicates that two objects have an attribution relationship with the same third object, or have the same identity information attribute. As two body parts are correlated objects, it can be considered that the two body parts belong to the same person.

By correlating the body parts in the image, it can further assist analyzing the behaviors and states of the person in a multi-person scenario, and the relationship between a plurality of persons.

### SUMMARY

In view of above, the present disclosure at least discloses a method of detecting correlated objects involved in an image. The method includes: detecting a face object, a hand object and a preset body part object involved in a target image, wherein the preset body part object represents a preset connection part between a face and a hand; respectively predicting correlation between the detected face object and the detected preset body part object, and correlation between the detected preset body part object and the detected hand object, to obtain a first correlation prediction result between the face object and the preset body part object, and a second correlation prediction result between the prese body part object and the hand object; and correlated objects involved in the target image are determined based on the first correlation prediction result and the second correlation prediction result.

The present disclosure also discloses an apparatus for detecting correlated objects involved in an image. The apparatus includes: a detector configured to detect a face object, a hand object and a preset body part object involved in a target image, where the preset body part object represents a preset part of a body connection part between a face and a hand; a first correlation predicting unit configured to respectively predict correlation between the detected face object and the detected preset body part object, and correlation between the detected preset body part object and the detected hand object, to obtain a first correlation prediction result between the face object and the preset body part object, and a second correlation prediction result between the preset body part object and the hand object; and a determining unit configured to determine correlated objects involved in the target image, based on the first correlation prediction result and the second correlation prediction result.

The present disclosure also discloses an electronic device, including: a processor; a memory for storing executable instructions of the processor; wherein the processor is configured to invoke the executable instructions stored in the memory to implement the method of detecting correlated objects involved in an image according to any one of the above examples.

A non-transitory computer-readable storage medium, wherein the storage medium stores a computer program, and the computer program is configured to perform the method of detecting correlated objects involved in an image according to any one of the above examples.

In the above solutions, by using a preset body part object which refers to a preset connection part between a face and a hand as an intermediary, respectively predicting correlation between the face object and the preset body part object, and correlation between the preset body part object and the hand object. Then, based on a prediction result between the face object and the preset body part object, and a prediction result between the preset body part object and the hand object, correlation between the detected face object and the hand object is determined. Compared with directly predicting correlation between a face and a hand, by introducing the preset body part object which is closely correlated with both the face and the hand as an intermediary, correlation between the face object and the hand object can be determined with higher accuracy. In addition, less interference information can be introduced when predicting correlation between a face and a hand, and accuracy of predicting correlation can be improved.

It should be understood that the general description and the following detailed description are only exemplary and explanatory, and cannot limit the present disclosure.

### BRIEF DESCRIPTION OF THE DRAWINGS

In order to more clearly describe the technical solutions in one or more examples of the present disclosure or related technologies, accompanying drawings that to be used in the description of the examples or related technologies will be briefly introduced in the following. Apparently, the accompanying drawings in the following description are only some of the examples described in one or more embodiments of the present disclosure. For those of ordinary skill in the art, other drawings can be obtained based on these drawings without creative labour.

FIG. 1 is a flowchart illustrating a method of detecting correlated objects involved in an image according to the present disclosure;

FIG. 2 is a flowchart illustrating a target detection method of detecting a face object, a hand object, and a preset body part object involved in a target image according to the present disclosure;

FIG. 3 is a flowchart illustrating a method of predicting correlation between a face object and a preset body part object according to the present disclosure;

FIG. 4 is a flowchart illustrating a method of predicting correlation between a face object and a preset body part object according to the present disclosure;

FIG. 5 is a flowchart illustrating a method of detecting correlated objects according to the present disclosure;

FIG. 6 is a flowchart illustrating a method of adjusting a prediction result according to the present disclosure;

FIG. 7 is a flowchart illustrating a method of training a neural network in the method of detecting correlated objects according to the present disclosure;

FIG. 8 is a block diagram illustrating an apparatus for detecting correlated objects involved in an image according to the present disclosure; and

FIG. 9 is a block diagram illustrating hardware structure of an electronic device according to the present disclosure.

### DETAILED DESCRIPTION OF THE EXAMPLES

Examples will be described in detail herein, with the illustrations thereof represented in the drawings. When the following descriptions involve the drawings, the same number in different drawings refers to same element or similar elements unless otherwise indicated. The embodiments described in the following examples do not represent all embodiments consistent with the present disclosure. Rather, they are merely examples of devices and methods consistent with some aspects of the present disclosure and as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plural forms, unless clearly indicated otherwise in the context. It should also be understood that the term “and/or” used herein includes any or all possible combinations of one or more of the correlated listed items. It should also be understood that, depending on the context, the word “if” as used herein may be interpreted as “when” or “upon” or “in response to determining”.

The present disclosure discloses a method of detecting correlated objects involved in an image. In the method, by using a preset body part object which refers to a preset connection part between a face and a hand as an intermediary, correlation between a face object and the preset body part object, and correlation between the preset body part object and a hand object are respectively predicted. Then, based on a prediction result between the face object and the preset body part object, and a prediction result between the preset body part object and the hand object, correlation between the detected face object and the hand object is determined. Compared with directly predicting correlation between a face and a hand, by introducing a preset body part object which is closely correlated with both the face and the hand as an intermediary, correlation between the face object and the hand object can be determined with improved accuracy. In addition, less interference information can be introduced when predicting correlation between a face and a hand, and accuracy of predicting correlation can be improved.

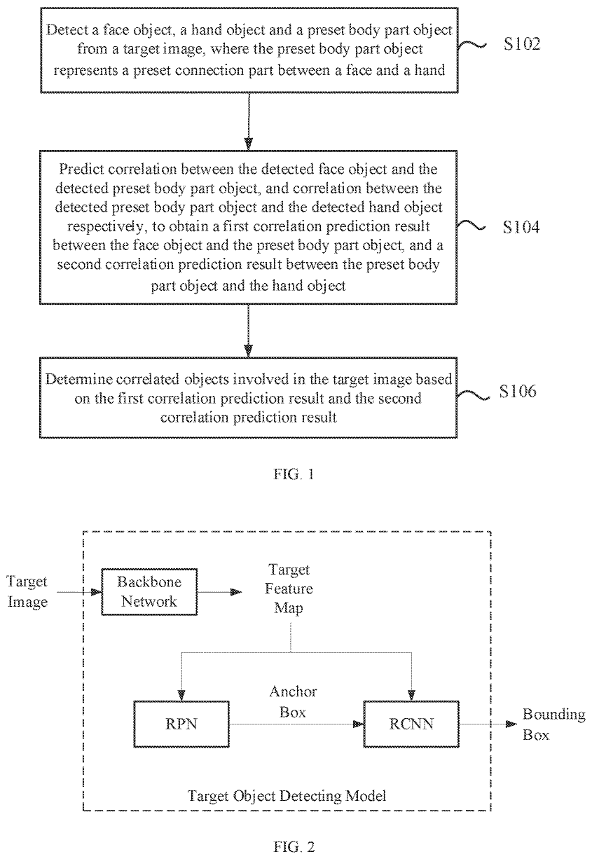

Referring to FIG. 1, FIG. 1 is a flowchart illustrating a method of detecting correlated objects involved in an image according to the present disclosure. As shown in FIG. 1, the method can include the following steps.

At S102, a face object, a hand object and a preset body part object are detected from a target image, where the preset body part object represents a preset connection part between a face and a hand.

At S104, correlation between the detected face object and the detected preset body part object, and correlation between the detected preset body part object and the detected hand object are predicted respectively, to obtain a first correlation prediction result between the face object and the preset body part object, and a second correlation prediction result between the preset body part object and the hand object.

At S106, based on the first correlation prediction result and the second correlation prediction result, correlated objects involved in the target image are determined.

The detection method can be applied to an electronic device. The electronic device can execute the method by installing a software system corresponding to the method. In examples of the present disclosure, the type of the electronic device can be a notebook computer, a computer, a server, a mobile phone, a PAD terminal, etc., which is not particularly limited in the present disclosure.

It is understandable that the method can be executed by either of a client device or a server device, or can be executed by both of the client device and the server device in cooperation.

For example, the method can be integrated in the client device. After receiving a correlated object detection request, the device can execute the method through the computing power provided by hardware of the device.

For another example, the method can be integrated into a server device. After receiving a correlated object detection request, the device can execute the method through the computing power provided by hardware of the device.

For another example, the method can be divided into two steps: obtaining a target image and performing correlated object detection on the target image. Here, the step of obtaining a target image can be performed by the client device, and the step of performing correlated object detection on the target image can be performed by the server device. The client device can initiate a correlated object detection request to the server device after obtaining the target image. After receiving the correlated object detection request, the server device can perform correlated object detection on the target image in response to the request.

The following description will be given with reference to an example in which the execution entity is an electronic device (hereinafter referred to as the device).

The target image refers to an image that needs image processing to extract useful information. The target image can involve several to-be-detected objects. For example, in a tabletop game scenario, the target image can involve some persons around the tabletop, as well as the persons' face objects, hand objects, and preset body objects(such as elbows).

In some examples, the device can interact with a user to obtain the target image input by the user. For example, the device can provide a window for a user to input the target image to be processed through its equipped interface. Thus, the user can complete the input of the target image based on this window.

In some examples, the device can also be connected to an image capture device deployed on-site in a to-be-captured scenario to obtain an image captured by the image capture device and take the image as a target image.

After the target image is obtained, the above S102 can be performed to detect the face object, the hand object, and the preset body part object involved in the target image, where the preset body part object represents a preset connection part between a face and a hand.

The preset body part object can represent a preset connection part between a face and a hand. Compared with directly predicting correlation between a face and a hand, by introducing a preset body part object that is more closely correlated with the face and the hand as an intermediary, correlation between the face object and the hand object can be determined with improved accuracy.

In some examples, the preset body part may refer to a preset body part object on the arm. In some examples, in order to improve the accuracy of predicting correlation, the preset body part objects can include at least one of a shoulder object, an elbow object, and a wrist object that are easier to be detected from the target image.

In this step, the target image can be input into a target object detecting network for target detection, to obtain the face object, the hand object and the preset body part object involved in the target image.

It should be understood that the result of target detection on the target image can include position information of the face object, the hand object and the preset body part object. The position information can include a bounding box and position information of the bounding box. When the bounding box is a rectangular box, the position information of the bounding box can include coordinate of at least one of the vertices, as well as length and width information of the bounding box.

The target object detecting network is used to perform target detection tasks. For example, the target object detecting network can be a neural network built based on a RCNN (Region Convolutional Neural Network), a FAST-RCNN (Fast a Region Convolutional Neural Network) or a FASTER-RCNN (Faster Region Convolutional Neural Network).

In practice, before detecting target with the target object detecting network, the network can be trained based on some training samples with position label information of the face object, the hand object and the preset body part object, until the network converges.

Referring to FIG. 2, FIG. 2 is a flowchart illustrating a target detection method of detecting a face object, a hand object, and a preset body part object involved in a target image according to the present disclosure. It should be noted that FIG. 2 only schematically illustrates the process of the target detection method, and does not limit the present disclosure.

As shown in FIG. 2, the target object detecting network can be a FASTER-RCNN, and can include at least Backbone (a backbone network), RPN (Region Proposal Network, a candidate box generating network), and RCNN (Region-based Convolutional Neural Network).

Here, the backbone network can perform some convolution operations on the target image to obtain a target feature map of the target image. Then, the target feature map can be processed by the RPN network to obtain anchors (anchor boxes) respectively corresponding to the target objects involved in the target image. After that, the anchor boxes output by the RPN network and the target feature map output by the backbone network can be processed by the RCNN network for bbox (bounding boxes) regression and classification to obtain bounding boxes respectively corresponding to the face object, the hand object, and the preset body part object involved in the target image.

It should be noted that in examples of the present disclosure, a same target object detecting network can be used to detect three different types of body part objects, and as well as categories and positions of the face object, the hand object, and the preset body part object involved in sample images are respectively marked in the training. When performing the target detection task, the target object detecting network can output a detection result for different types of body part objects and body objects.

After determining the bounding boxes respectively corresponding to the face object, the hand object, and the preset body part object, S104 can be performed to predict correlation between the detected face object and the detected preset body part object, and correlation between the detected preset body part object and the detected hand object, to obtain a first correlation prediction result between the face object and the preset body part object, and a second correlation prediction result between the preset body part object and the hand object.

The correlation predicting mentioned above specifically refers to detecting correlation between two objects. In practice, a probability or a confidence that two objects belong to the same body object can be calculated, to detect the correlation between the two objects. The two objects can include a face object and a preset body object, or a preset body object and a hand object.

In some examples, a probability that the detected face object and the detected preset body object belong to the same body object, and a probability that the detected preset body object and the detected hand object belong to the same body object can be calculated based on features such as distance, relative position relationship, colour correlation degree between two objects in the image, and prior knowledge such as the distance, relative position relationship, colour of two correlated objects in an actual scene, and be taken as the first correlation prediction result and the second correlation prediction result respectively.

In some examples, the correlation predicting can be performed through a correlation predicting model which is constructed based on a neural network, to obtain a confidence that two objects belong to the same body object.

In some examples, the degree of confidence can be quantified by a prediction score. The higher the prediction score is, the higher the probability that the two parts belong to the same body will be.

It should be understood that, in some cases, the target image can involve a plurality of face objects, a plurality of hand objects, and a plurality of preset body part objects. In the method of the present disclosure, the face objects can be randomly combined with the hand objects to form a plurality of first combinations, which are respectively used to predict the correlation between the face object and the hand object. In this case, when determining the first correlation prediction result, S1042 can be performed first, in which each of the detected face objects are combined with each of the preset body part objects to obtain a plurality of second combinations.

Before performing S1042, a unique identifier can be created for each detected face object, each hand object, and each preset body part object.

In some examples, a unique identifier can be created for each object based on the category of each object and a list of integer numbers. For example, the created identifier can be a face object F1, a face object F2, a hand object H1, a preset body part object E1, etc., where “F”, “H” and “E” are used to identify the categories of the face object, the categories of the hand objects and the categories of the preset body part objects.

After the identifiers are created, each of the face objects can be used as the target face object in turn, and combined with each of the preset body part objects according to the identifiers, to obtain a plurality of second combinations. It should be understood that all the object combination methods involved in the present application can refer to the combination method of the second combination described above, which will not be described in detail later.

After a plurality of second combinations are obtained, S1044 can be performed, in which obtaining a first correlation prediction result between the face object and the preset body part object in each of the second combinations by, for each of the second combinations, predicting correlation on the face object and the preset body part object in the second combination based on the visual features of the face object and the preset body part object in the second combination.

In some examples, correlation predicting can be performed based on a correlation predicting model. The correlation predicting model can be a regression model or a classification model constructed based on a visual feature extracting unit. The predicting model can include a fully connected layer, and finally output a correlation prediction score.

Here, the fully connected layer can be a calculating unit constructed based on algorithms such as linear regression and least square regression. The calculating unit can perform feature mapping on the visual features to obtain the corresponding correlation prediction score value.

In practice, the calculating unit can be trained based on several training samples with label information on correlations between face objects and preset body part objects.

When constructing training samples, several original images can be first obtained, face objects and preset body part objects involved in the original images are randomly combined with an annotation tool, to obtain a plurality of combinations. Afterwards correlation labeling between the face object and the preset body part object in each combination is performed. If the face object in a combination is correlated to the preset body part object (belonging to the same person), it can be labelled with 1, otherwise it can be labelled with 0. Alternatively, when the original image is labelled, information of a person object (such as a person ID) to which a face object and a preset body part object belong can be labelled respectively. Thus, it can be determined whether the face object is correlated to the preset body part object in the combination based on whether the information of the person to which the face object belongs and the information of the person to which the preset body part object belongs is consistent.

Referring to FIG. 3, FIG. 3 is a flowchart illustrating a method of predicting correlation between a face object and a preset body part object according to the present disclosure.

As an example, the correlation predicting model shown in FIG. 3 can include a visual feature extracting unit and a fully connected layer.

The visual feature extracting unit can obtain a feature region based on a bounding box and a target feature map corresponding to the target image.

For example, the visual feature extracting unit can be a Rol Align (Region of interest Align) unit or a Rol pooling (Region of interest pooling) unit.

The fully connected layer can be a unit constructed based on algorithms such as linear regression and least square regression. This unit can perform feature mapping (matrix operation) on the feature region (pixel matrix) to obtain a corresponding correlation prediction score value.

When predicting with the correlation predicting model, the bounding boxes of the face object and the preset body part object in each second combination, and the target feature map corresponding to the target image can be input to the visual feature extracting unit, to obtain the visual features corresponding to the face object and the preset body part object.

Then, the visual features are input into the fully connected layer to calculate the first correlation prediction result.

In some examples, in order to improve the accuracy of predicting correlation, when calculating the first correlation prediction score, for each of the second combinations, based on the visual features and the position features of the face object and the preset body part object in the second combination, correlation predicting model can be used to predict correlation of the face object with respect to the preset body part object in the second combination, to obtain a first correlation prediction result between the face object and the preset body part object in each of the second combinations. Here, the visual features include features such as colour and/or texture, and the position features include features such as coordinate positions, relative positional relationships with other objects, and the like.

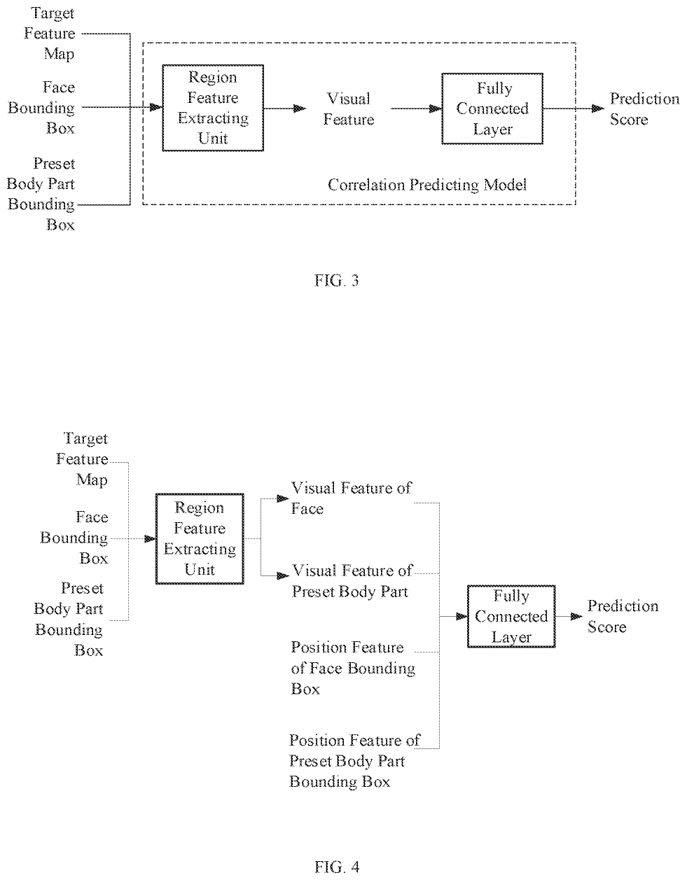

Referring to FIG. 4, FIG. 4 is a flowchart illustrating a method of predicting correlation between a face object and a preset body part object according to the present disclosure.

As shown in FIG. 4, after the visual features corresponding to the face object and the preset body part object respectively are extracted by the visual feature extracting unit, feature splicing (for example, single-core convolution operation, superposition, etc.) is performed on the position features (for example, coordinates) of the face object and the position features of the preset body part object, to obtain a spliced feature.

After the spliced feature is obtained, the spliced feature can be input into the fully connected layer for performing feature mapping (matrix operation) to obtain the first correlation prediction result.

In correlation predicting, in addition to the visual features of the face object and the preset body part object, the position features respectively corresponding to the bounding boxes of the face object and the preset body part object are also used. Thus, information such as the potential positional relationship between body parts can be extracted, and the extracted information which is useful for predicting the correlation between body part objects can be introduced, thereby improving the accuracy of the correlation prediction result.

Then, S1046 can be performed to combine each of the detected preset body part objects with each of the hand objects to form a plurality of third combinations.

At S1048, a second correlation prediction result between the preset body part object and the hand object in each of the third combinations is obtained by, for each of the third combinations, predicting correlation of the hand object with respect to the preset body part object in the third combinations based on the visual features and position features of the preset body part object and the hand object in the third combination.

It should be understood that the description of step S1046-S1048 can refer to the description of step S1042-S1044, which is not described in detail here.

It should be noted that this application does not specifically limit the sequence of determining the first correlation prediction result and the second correlation prediction result. For example, S1042-S1044 can be performed first, or S1046-S1048 can be performed first, or predicting the first correlation prediction result and the second correlation prediction result can be performed simultaneously.

After obtaining a plurality of first correlation prediction results and a plurality of second correlation prediction results, the process can be proceeded to S106, in which correlated objects involved in the target image can be determined based on the first correlation prediction results and the second correlation prediction results.

In some examples, based on the first correlation prediction results and the second correlation prediction results, a face object and a hand object of which correlations with respect to the same preset body part object satisfy a preset condition can be determined as the correlated objects involved in the target image.

The preset condition can be set based on actual business requirements. In some examples, the preset condition may specify that the confidence of the correlation with respect to the same preset body part object reaches a preset threshold (empirical threshold).

In some examples, the first correlation prediction results that reach the first preset threshold (empirical threshold) can be selected from the plurality of first correlation prediction results, and the face object and the preset body part object corresponding to the first correlation prediction result are determined as a pair of preliminarily correlated face object and preset body part object.

Afterwards, a number of face objects preliminarily correlated with the same preset body part object can be determined.

If the number of face objects preliminarily correlated with the same preset body part object is 1, it is determined that the face object is correlated with the hand object.

If the number of face objects preliminarily correlated with the same preset body part object is greater than 1, from the plurality of face objects preliminarily correlated with the preset body part object, a face object which has the largest correlation with the preset body part object is determined, and the face object is determined as a face object correlated with the preset body part object.

Then, based on a similar method, the hand object correlated with the preset body part object can be determined.

After the face object and the hand object correlated with the same preset body part object are determined, the face object and the hand object can be determined as a pair of correlated objects belonging to the same body object.

In the above solutions, since the preset body part object is the preset connecting part between a face and a hand, the preset body part object is closely related to the hand object and the face object. In predicting the correlation between the face object and the hand object, the actually correlated face object and the hand object can be correlated through intermediate information, which can improve the accuracy of the detection result of the correlated object.

In some examples, in order to improve the accuracy of predicting correlation, when performing S106, correlation between the detected face object and the detected hand object can be predicted first to obtain a third correlation prediction result. Then, auxiliary information which is useful for predicting the correlation between the face object and the hand object can be extracted from the first correlation prediction result and the second correlation prediction result. Afterwards, based on the auxiliary information, the third correlation prediction result can be adjusted, and based on the adjusted third correlation prediction result, the correlated objects involved in the target image can be determined, thereby the accuracy of predicting correlation can be improved.

The above steps are described below with reference to the drawings.

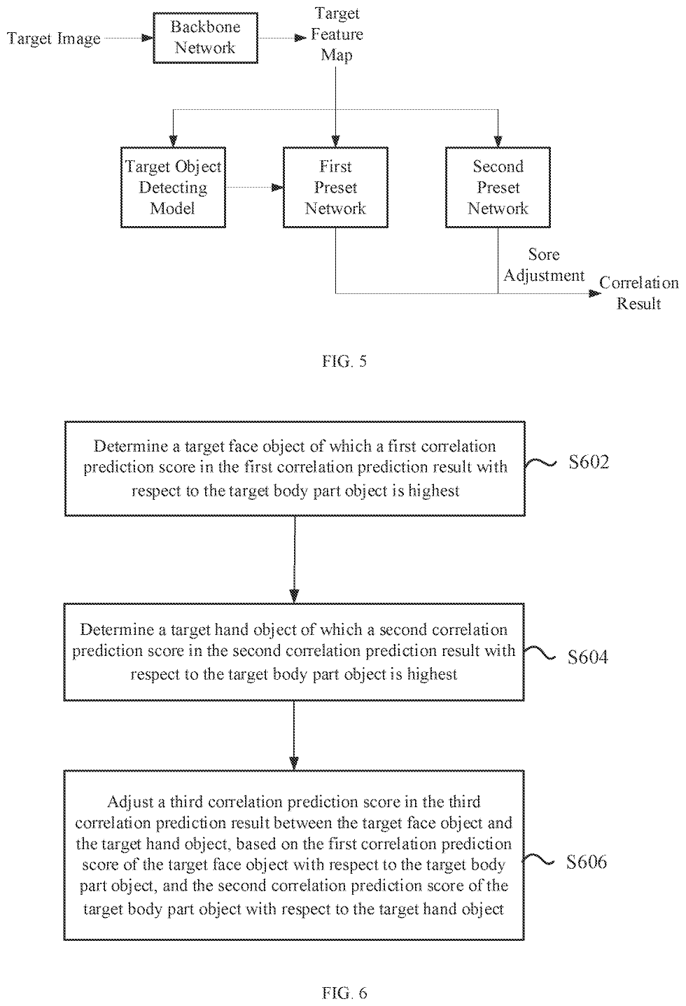

Referring to FIG. 5, FIG. 5 is a flowchart illustrating a method of detecting correlated objects according to the present disclosure.

The process shown in FIG. 5 includes at least a target object detecting network, a first preset network and a second preset network. The target object detecting network is configured to detect face objects, hand objects, and preset body part objects involved in the target image. The first preset network is configured to predict correlation between a face object and a hand object to obtain a third correlation prediction result. The second preset network is configured to predict correlation between a face object and a preset body part object, and correlation between a preset body part object and a hand object, to obtain a first correlation prediction result and a second correlation prediction result respectively.

As shown in FIG. 5, in predicting the correlation, a target image can be input into a target object detecting network, and target detecting is performed to obtain bounding boxes of face objects, hand objects, and preset body part objects involved in the target image.

Then, the first preset network can be used to predict correlation between the detected face objects and hand objects to obtain third correlation prediction results. It should be understood that the description of the step of predicting the third correlation prediction result can refer to the description of the steps of S1042-S1044, which will not be elaborated herein.

Then, the second preset network can be used to predict correlation between the detected face objects and the preset body part object, as well as the preset body part object and the hand objects respectively, to obtain first correlation prediction results regarding correlations between the face objects and the preset body part objects, and second correlation prediction results regarding correlations between the preset body part object and the hand objects.

After that, the third correlation prediction result can be adjusted based on the first correlation prediction result and the second correlation prediction result. In some optional implementations, the first correlation prediction result and the second correlation prediction result can be used to verify the third correlation prediction result. The credibility of the third correlation prediction result can be increased if the verification is passed, otherwise the credibility of the third correlation prediction result is reduced or the third correlation prediction result is adjusted to “not correlated”.

As an example, if it is determined based on a first correlation prediction result that a face object Fl is correlated with a preset body part object El, it is determined based on a second correlation prediction result that the preset body part object El is not correlated with a hand object H1, and it is determined based on a third correlation prediction result that the face object Fl is correlated with the hand object H1, then the third correlation prediction result between the face object Fl and the hand object H1 can be determined to be: not correlated.

In some examples, the correlation prediction result can include a correlation prediction score.

Referring to FIG. 6, FIG. 6 is a flowchart illustrating a method of adjusting a prediction result according to the present disclosure.

As shown in FIG. 6, each of the detected preset body part objects can be used in turn as a target body part object, and the following operations can be performed.

At S602, it is to determine a target face object of which a first correlation prediction score in the first correlation prediction result with respect to the target body part object is highest.

In some examples, the first correlation prediction scores corresponding to the target body part objects can be sorted in descending order. The face object corresponding to the first correlation prediction score ranked first can be determined as the target face object.

Thus, the face object having the highest correlation with the target body part object can be obtained.

In some examples, candidate face objects can be determined in a way that the first correlation prediction score of each candidate face object with respect to the target body part object is greater than a preset threshold. Then, from the candidate face objects, the one having the highest first correlation prediction score is selected as the target face object.

The preset threshold is an empirical threshold. If the correlation prediction score of two body objects reaches the preset threshold, it indicates that the two body objects are more likely to belong to the same person.

In the above examples, if the first correlation prediction score between the face object and the preset body part object is lower than the preset threshold, the candidate face object cannot be determined. In this case, it can indicate that the face object and the preset body part do not belong to the same person (it can be caused by the preset body part belonging to the same person as the face object being blocked), so there is no need to adjust the third correlation prediction score corresponding to the face object based on the first correlation prediction score. Thus, on the one hand, the amount of model calculation can be reduced and the efficiency of detecting correlated object can be improved; on the other hand, useless correction can be avoided and the accuracy of detecting correlated object can be improved.

Then, S604 can be performed, it is to determine a target hand object of which a second correlation prediction score in the second correlation prediction result with respect to the target body part object is highest.

In some examples, the second correlation prediction scores corresponding to the target body part objects can be sorted in descending order. The hand object corresponding to the second correlation prediction score ranked first can be determined as the target hand object.

Thus, the hand object having the highest correlation with the target body part object can be obtained.

In some examples, candidate hand objects can be determined in a way that the second correlation prediction score of the candidate hand object with respect to the target body part object is greater than a preset threshold. From the candidate hand objects, the one having the highest second correlation prediction score is determined as the target hand object.

The preset threshold is an empirical threshold. If the correlation prediction score of two body objects reaches the preset threshold, it indicates that the two body objects are more likely to belong to the same person.

In the above examples, if the second correlation prediction score between the hand object and the preset body part object is lower than the preset threshold, then the candidate hand object cannot be determined. In this case, it can indicate that the hand object and the preset body part do not belong to the same person (it can be caused by the preset body part belonging to the same person as the hand object being blocked), so there is no need to adjust the third correlation prediction score corresponding to the hand object based on the second correlation prediction score. Thus, on the one hand, the amount of model calculation can be reduced and the efficiency of detecting correlated object can be improved; on the other hand, useless correction can be avoided and the accuracy of detecting correlated object can be improved.

Finally, S606 can be performed, in which based on the first correlation prediction score of the target face object with respect to the target body part object, and the second correlation prediction score of the target body part object with respect to the target hand object, a third correlation prediction score in the third correlation prediction result between the target face object and the target hand object is adjusted.

In some examples, an average value of the first correlation prediction score of the target face object with respect to the target body part object, and the second correlation prediction score of the target hand object with respect to the target body part object can be determined first.

The adjusted third correlation prediction score is obtained by adding the average value to the third correlation prediction score between the target face object and the target hand object.

It should be noted here that there can be many ways to adjust the third correlation prediction score. For example, the sum of the first correlation prediction score, the second correlation prediction score, and the third correlation prediction score is directly determined as the adjusted third correlation prediction score. For another example, the sum of the third correlation prediction score and the first correlation prediction score or the second correlation prediction score is determined as the adjusted third correlation prediction score. In the present disclosure, the adjustment methods of the third correlation prediction score are not exhaustively listed.

After completing the adjustment of the third correlation prediction result, the correlation between the detected face object and the detected hand object can be determined based on the adjusted third correlation prediction result. Whether the face object in the image is correlated with the hand object can be determined by the third correlation prediction result. For example, whether the face object and the hand object are correlated can be determined by whether the correlation prediction score representing the third correlation prediction result exceeds a threshold.

At this step, it is also possible to select each from a plurality of the third correlation prediction scores in an order of the third correlation prediction scores from high to low, and for a current combination of the face object and the hand object corresponding to the selected third correlation prediction score perform the following first and second steps.

In the first step, based on the determined correlated objects involved in the target image, it is determined whether a number of hand objects that are correlated with the face object in the current combination reaches a first preset threshold, and it is determined whether a number of face objects that are correlated with the hand object in the current combination reaches a second preset threshold.

The first preset threshold is an empirical threshold that can be set according to actual situations. Here, the first preset threshold can be 2.

The second preset threshold is an empirical threshold that can be set according to actual situations. Here, the second preset threshold can be 1.

In some examples, a combination with a correlation prediction score reaching a preset score threshold can be determined as current pair of objects, based on an order of the third correlation prediction scores from high to low.

In the examples of the present disclosure, a combination with a correlation prediction score reaching a preset score threshold can be determined as current pair of objects. Correlation determination is performed on the current pair of objects, thereby the accuracy of the correlation prediction result can be improved.

In some examples, a counter can be maintained for each face object and each hand object. For any face object, if one hand object is determined as being correlated with the face object, the value of the counter corresponding to the face object is increased by 1. In this case, two counters can be used to determine whether the number of hand objects that are correlated with the face object reaches the first preset threshold, and to determine whether the number of face objects that are correlated with the hand object in the current pair of objects reaches the second preset threshold.

In the second step, in response to that the number of hand objects that are correlated with the face object in the current combination is lower than the first preset threshold, and the number of face objects that are correlated with the hand object in the current combination is lower than the second preset threshold, the face object and the hand object in the current combination are determined as correlated objects involved in the target image.

According to the above solutions, in complex scenarios (for example, the target image involves a plurality of people with overlapping faces, limbs, and hands), it can avoid unreasonable prediction such as that one face object is predicted as being correlated with more than two hand objects or that one hand object is predicted as being correlated with more than one face object. For example, in a multiplayer tabletop game scenario, where hands or faces of different people may overlap or shield each other, the solutions can correlate hands with respective faces with a higher accuracy.

Since a face object and a hand object that are strongly correlated to the same preset body part object are very likely to belong to the same person in actual situations, predicting correlated objects based on the adjusted third correlation prediction score can effectively improve the accuracy of predicting correlation.

In some examples, the detection result of the correlated objects involved in the target image can be output.

For example, in a tabletop game scenario, a bounding box corresponding to the face object and the hand object indicated by the correlated objects can be output on an image output device (such as a display). By outputting the detection result of the correlated objects on the image output device, an observer can conveniently and intuitively determine the correlated objects involved in the target image displayed on the image output device, thereby facilitating further manual verification on the detection result of the correlated objects.

The following will describe an example in a tabletop game scenario. It should be understood that for implementation in other scenarios, reference can be made to the description of the tabletop game scenario example in the present disclosure, which is not described in detail here.

In a tabletop game scenario, a game table is usually provided, and game participants surround the game table. An image capture device for capturing live images of a tabletop game can be deployed in the tabletop game scenario. The live image can involve the faces, hands, and elbows of the game participants. In this scenario, it is expected to determine the hand and face that are correlated objects involved in the live image, so that the personal identity information to which the hand belongs can be determined based on the face correlated with the hand involved in the image.

Here, the hand and the face are correlated objects, or the hand and the face are correlated, which means that the two belong to the same body, that is, the two are the hand and the face of the same person.

In this scenario, a detection device for detecting correlation between a face and a hand can also be deployed. The device can obtain live images from the image capture device and determine the correlated objects involved in the live images.

The detection device can be equipped with a trained face-elbow-hand object detecting network, a face-hand correlation predicting network, and a face-elbow-hand correlation predicting network. The input of the correlation predicting network can include the output of the face-elbow-hand object detecting network.

The face-elbow-hand object detecting network can include a neural network constructed based on the FASTER-RCNN network. The object detecting network can detect bounding boxes respectively corresponding to face objects, hand objects, and elbow objects from live images.

The face-hand correlation predicting network and the face-elbow-hand correlation predicting network can be a neural network constructed based on a region feature extracting unit and a fully connected layer.

The face-elbow-hand correlation predicting network can extract visual features corresponding to the face and the hand, and combine the position features of the bounding boxes corresponding to the face and the hand which are detected by the object detecting network, to predict a third correlation prediction score between the face and the hand.

The face-elbow-hand correlation predicting network can include a face-elbow correlation predicting network and an elbow-hand correlation predicting network. The face-elbow-hand correlation predicting network can respectively predict the first correlation prediction score between the detected face and the detected elbow, and the second correlation prediction score between the detected elbow and the detected hand.

In the examples of the present disclosure, the detection device can obtain live images from the image capture device in response to a user's operation or periodically.

Then, the object detecting network can be used to detect the face objects, the hand objects, and the elbow objects involved in the live image.

Then, any of detected face objects and any of detected hand objects can be combined to obtain a plurality of first combinations. After that, for each of the first combinations, the face-hand correlation predicting network is used to predict a correlation between the face and the hand in the first combination, to obtain a third correlation prediction score between the face and the hand in each of the first combinations.

Similarly, any of the detected faces and any of detected elbows can be combined to obtain a plurality of second combinations, and any of the detected elbows and any of the detected hands can be combined to obtain a plurality of third combinations. First correlation prediction scores between the faces and the elbows in the second combinations, and second correlation prediction scores between the elbows and the hands in the third combinations, can be respectively predicted with the face-elbow-hand correlation predicting network.

Since a face object and a hand object that are strongly correlated to the same elbow object are very likely to belong to the same person in actual situations, performing correlated object prediction based on the adjusted third correlation prediction scores can improve the accuracy of predicting correlation effectively.

After that, each of the detected elbows can be taken as the target elbow in turn, to perform the following step:

determining a target face object of which a first correlating prediction score in the first correlation prediction result with respect to the target elbow reaches a first preset threshold and has the largest value; determining a target hand object of which a second correlating prediction score in the second correlation prediction result with respect to the target elbow reaches a second preset threshold and has the largest value. Then, an average of the determined first correlation prediction score and the determined second correlation prediction score is calculated, and a sum of the average and the third correlation prediction score between the target face and the target hand is calculated, to obtain an adjusted third correlation prediction score.

In the detection device, a counter can also be maintained for each face object and each hand object. For any face object, if one hand object is determined as being correlated with the face object, the value of the counter corresponding to the face object is increased by 1. In this case, two counters can be used to determine whether the number of hand objects that are correlated with the face object reaches the first preset threshold, and to determine whether the number of face objects that are correlated with the hand object in the current pair of objects reaches the second preset threshold.

Further, it is possible to determine each of the combinations as the current combination in turn in the order of the third correlation prediction scores from high to low, and perform the following steps:

obtaining a first value from the counter corresponding to the face object in the current combination, and determining whether the first value reaches 2; and obtaining a second value from the counter corresponding to the hand object in the current combination, and determining whether the second value reaches 1.

If the first value is lower than 2 and the second value is lower than 1, it means that the number of hand object that correlated with the face object is less than 2, and the number of face object that correlated with the hand object is less than 1. Therefore, the face object and the hand object of the current objects pair can be determined as correlated objects involved in the live image.

According to the above solutions, in complex scenarios (for example, the target image involves a plurality of people with overlapping faces, limbs, and hands), it can avoid unreasonable prediction such as that one face object is predicted as being correlated with more than two hand objects or that one hand object is predicted as being correlated with more than one face object.

The detection device is also equipped with a display unit.

The display unit can output a bounding box involved the face object and the hand objected indicated by the correlated objects on the display mounted on the detection device. By outputting the detection result of the correlated objects on the display, an observer can determine the correlated objects involved in the live image displayed on the image output device conveniently and intuitively, thereby facilitating further manual verification on the detection result of the correlated objects.

The detection device can also obtain live images in real time, and determine the correlated hand objects and face objects from the live images. The detection device can recognize the action being performed or the area being touched by the hand object involved in the live image. If the detection device recognizes that the hand object performed actions such as fetching/releasing game props, or touching a preset game area, the personal identity of the relevant person can be determined based on the face object correlated with the hand object. After that, the identity of the determined person can be output to facilitate the management of the tabletop game manager.

The solution of determining correlated objects involved in the target image according to the present disclosure has been described above. In the following, a method of training a target object detecting model and a correlation predicting network used in the solution will be described.

In the present disclosure, in order to improve the accuracy of the determination results of correlated face object and hand object, each model can be trained in stages. The first stage is the training of the target object detecting network; and the second stage is the joint training of the target object detecting network and the correlation predicting model.

Referring to FIG. 5, as shown in FIG. 5, a target object detecting network, a first preset network, and a second preset network can be included. The target object detecting network is configured to detect a face object, a hand object, and a preset body part object involved in the target image. The first preset network is configured to predict a third correlation prediction result between the face object and the hand object. The second preset network is used to predict the first correlation prediction result between the face object and the preset body part object, and the second correlation prediction result between the preset body part object and the hand object.

The first preset network includes a face-hand correlation detecting model; the second preset network includes a face-preset-body-part correlation detecting model and a preset-body-part-hand correlation detecting model. The target object detecting network, the face-hand correlation detecting model, the face-preset-body-part correlation detecting model, and the preset-body-part-hand correlation detecting model share the same backbone network.

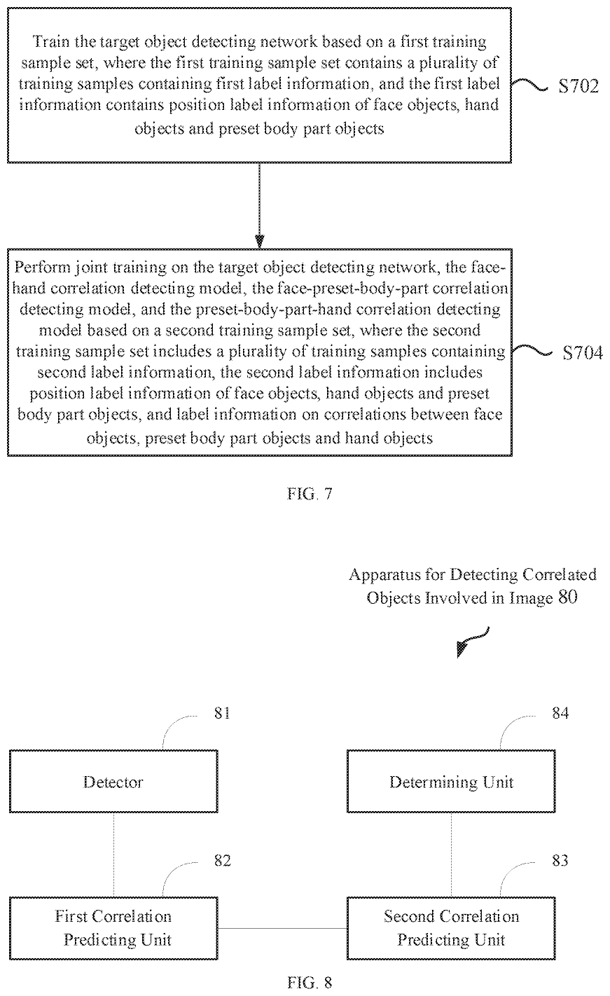

Referring to FIG. 7, FIG. 7 is a flowchart illustrating a method of training a neural network in the method of detecting correlated objects according to the present disclosure.

As shown in FIG. 7, the method includes the following steps.

At S702, the target object detecting network is trained based on a first training sample set; where the first training sample set contains a plurality of training samples containing first label information; the first label information contains position label information of face objects, hand objects and preset body part objects. In some examples, the position label information can include position label information of bounding boxes.

At this step, the original image can be labelled with a true or false value by manual labelling or machine-aided labelling. For example, in a tabletop game scenario, after obtaining the original image, an image annotation tool can be used to label position label information respectively corresponding to the bounding boxes of the face object, the bounding box of the hand object, and the bounding box of the preset body part object involved in the original image, to obtain several training samples. It should be noted that when encoding the training samples, one-hot encoding and other methods can be used for encoding, and the specific encoding method is not limited in the present disclosure.

After that, the target object detecting network can be trained based on the preset loss function until the network converges.

Then at S704, joint training is performed on the target object detecting network, the face-hand correlation detecting model, the face-preset-body-part correlation detecting model, and the preset-body-part-hand correlation detecting model based on a second training sample set. The second training sample set includes a plurality of training samples containing second label information. The second label information includes position label information of face objects, hand objects and preset body part objects, and label information on correlations between face objects, preset body part objects and hand obj ects.

When this step is performed, the original image can be labelled with a true or false value by manual labelling or machine-aided labelling. For example, after obtaining the original image, on one hand, an image annotation tool can be used to label position label information respectively corresponding to the bounding boxes of the face objects and the bounding boxes of the hand objects and the bounding boxes of the preset body part objects (such as elbows) involved in the original image; on the other hand, the image annotation tool can be used to randomly combine the face objects and the preset body part objects involved in the original image, randomly combine the face objects and the hands objects involved in the original image, and randomly combine the preset body part objects and the hands objects involved in the original image, to obtain a plurality of combinations. Then, the two parts in each combination are labelled with a correlation result. In some examples, if the two parts in one combination has correlation (belonging to the same person), then 1 is labelled; otherwise, 0 is labelled.

After a second training sample set is determined, a joint learning loss function can be determined based on the loss functions respectively corresponding to the models.

In some examples, the loss functions respectively corresponding to the models can be added to obtain the joint learning loss function.

It should be noted that, in the present disclosure, a hyper parameter such as regularization items can also be added to the joint learning loss function. The type of hyper parameter to be added is not particularly limited here.

After that, the models can be jointly trained based on the joint learning loss function and the second training sample set until the models converge.

Since the supervised joint training method is used in the model training, the models can be trained simultaneously, so that the models can restrict and promote each other in the training process. It can improve the convergence efficiency of the models on the one hand; on the other hand, promote the backbone network shared by all models to extract more beneficial features for predicting correlation, thereby improving the accuracy of predicting correlation.

Corresponding to any of the above implements, the present application also proposes an apparatus 80 for detecting correlated objects involved in an image.

Referring to FIG. 8, FIG. 8 is a block diagram illustrating an apparatus for detecting correlated objects involved in an image according to the present disclosure.

As shown in FIG. 8, the apparatus 80 includes: a detector 81 configured to detect a face object, a hand object and a preset body part object involved in a target image, where the preset body part object represents a preset connection part between a face and a hand; a first correlation predicting unit 82 configured to respectively predict correlation between the detected face object and the detected preset body part object, and correlation between the detected preset body part object and the detected hand object, to obtain a first correlation prediction result between the face object and the preset body part object, and a second correlation prediction result between the preset body part object and the hand object; a determining unit 84 configured to, based on the first correlation prediction result and the second correlation prediction result, determine correlated objects involved in the target image.

In some illustrated examples, the apparatus 80 also includes: the second correlation predicting unit 83 configured to predict correlation between the detected face object and the detected hand object to obtain a third correlation prediction result. The determining unit 84 includes: an adjustment sub-unit configured to adjust the third correlation prediction result based on the first correlation prediction result and the second correlation prediction result; a determining sub-unit configured to determine correlated objects involved in the target image based on the adjusted third correlation prediction result.

In some illustrated examples, the target image involves a plurality of face objects and a plurality of hand objects. The second correlation predicting unit 83 is specifically configured to: combining each of the detected face objects with each of the detected hand objects to form a plurality of first combinations; obtaining a third correlation prediction result between the face object and the hand object in each of the first combinations by, for each of the first combinations, predicting correlation between the face object and the hand object in the first combination based on visual features and position features of the face object and the hand object in the first combination, predict correlation between the face object and the hand object in the first combination.

In some illustrated examples, the target image also involves a plurality of preset body part objects. The first correlation predicting unit 82 is specifically configured to: combining each of the detected face objects with each of the detected preset body part objects to form a plurality of second combinations; obtaining a first correlation prediction result between the face object and the preset body part object in each of the second combinations by, for each of the second combinations, predicting correlation on the face object and the preset body part object in the second combination based on visual features and position features of the face object and the preset body part object in the second combination; combining each of the detected preset body part objects with each of the hand objects to form a plurality of third combinations; and obtaining a second correlation prediction result between the preset body part object and the hand object in each of the third combinations by, for each of the third combinations, predicting correlation between the preset body part object and the hand object in the third combination based on visual features and position features of the preset body part object and the hand object in the third combination.

In some illustrated examples, the correlation prediction result includes a correlation prediction score. The determining sub-unit is specifically configured to: take each of the detected preset body part objects as a target body part object, and perform the following operations: determining a target face object of which a first correlation prediction score in the first correlation prediction result with respect to the target body part object is highest; determining a target hand object of which a second correlation prediction score in the second correlation predication result with respect to the target body part object is highest; and based on the first correlation prediction score of the target face object with respect to the target body part object, and the second correlation prediction score of the target body part object with respect to the target hand object, adjusting a third correlation prediction score in the third correlation prediction result between the target face object and the target hand object.

In some illustrated examples, the determining sub-unit is specifically configured to: determine candidate face objects, where each of the candidate face objects has a first correlation prediction score with respect to the target body part object greater than a preset threshold; selecting one from the candidate face objects of which the first correlation prediction score with respect to the target body part object is highest as the target face object; and/or determining a target hand object of which a second correlation prediction score in the second correlation predication result with respect to the target body part object is highest comprises: determining candidate hand objects wherein each of the candidate hand objects has a second correlation prediction score with respect to the target body part object greater than a preset threshold; and selecting one from the candidate hand objects of which the second correlation prediction score with respect to the target body part object is highest as the target hand object.

In some illustrated examples, the determining sub-unit is specifically configured to: determine an average value of the first correlation prediction score of the target face object with respect to the target body part object, and the second correlation prediction score of the target hand object with respect to the target body part object; and obtain the adjusted third correlation prediction score by adding the average value to third correlation prediction score between the target face object and the target hand object.

In some illustrated examples, the determining sub-unit is specifically configured to: selecting each from a plurality of the third correlation prediction scores in an order of the third correlation prediction scores from high to low, and for a current combination of the face object and the hand object corresponding to the selected third correlation prediction score, based on determined correlated objects involved in the target image, determining a number of hand objects that are correlated with the face object in the current combination as a first number, and determining a number of face objects that are correlated with the hand object in the current combination as a second number; in response to that the first number is lower than a first preset threshold, and the second number is lower than a second preset threshold, determining the face object and the hand object in the current combination as correlated objects involved in the target image.

In some illustrated examples, the determining unit 84 is specifically configured to: based on the first correlation prediction result and the second correlation prediction result, determine a face object and a hand object of which correlations with respect to a same preset body part object satisfying a preset condition as correlated objects involved in the target image.

In some illustrated examples, the apparatus 80 also comprises: an output unit configured to output a detection result of the correlated objects involved in the target image.

In some illustrated examples, the preset body part object comprises at least one of a shoulder object, an elbow object and a wrist object.

In some illustrated examples, the face object, the hand object, and the preset body part object involved in the target image are detected from the target image by a target object detecting network; the third correlation prediction result is detected by a first preset network comprising a face-hand correlation detecting model; the first correlation prediction result and the second correlation prediction result are detected by a second preset network comprising a face-preset-body-part correlation detecting model and a preset-body-part-hand correlation detecting model; the target object detecting network, the face-hand correlation detecting model, the face-preset-body-part correlation detecting model and the preset-body-part-hand correlating model are trained by: training the target object detecting network based on a first training sample set which comprises a plurality of training samples with respective first label information, wherein the first label information contains respective position label information of face objects, hand objects and preset body part objects; and jointly training the target object detecting network, the face-hand correlation detecting model, the face-preset-body-part correlation detecting model, and the preset-body-part-hand correlation detecting model based on a second training sample set which comprises a plurality of training samples with respective second label information, wherein the second label information includes respective position label information of face objects, hand objects and preset body part objects, and respective label information on correlations between face objects, preset body part objects and hand obj ects.

The examples of the apparatus for detecting correlated objects involved in an image according to the present disclosure can be used in an electronic device. Correspondingly, the present disclosure discloses an electronic device, which can include a processor; a memory configured to store executable instructions of the processor. The processor is configured to invoke the executable instructions stored in the memory to implement the method of detecting correlated objects in an image as shown in any of the examples.

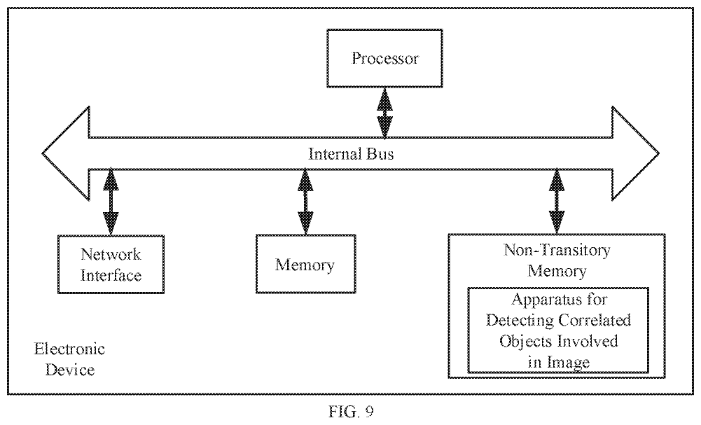

Referring to FIG. 9, FIG. 9 is a block diagram of hardware of an electronic device according to the present disclosure.

As shown in FIG. 9, the electronic device can include a processor for executing instructions, a network interface for network connection, a memory for storing operating data for the processor, and a non-transitory memory for storing instructions corresponding to the apparatus for detecting correlated objects involved in an image.

The examples of the apparatus for detecting correlated objects involved in an image can be implemented by software, or can be implemented by hardware or a combination of software and hardware. Taking software implementation as an example, as a logical device, it is formed by reading the corresponding computer program instructions in the non-transitory memory into the memory through the processor of the electronic device where it is located. From a hardware perspective, in addition to the processor, memory, network interface, and non-transitory memory shown in FIG. 9, the electronic device in which the device is located in the example usually includes other hardware based on the actual functions of the electronic device, which will not be elaborated here.

It should be understood that, in order to improve the processing speed, the corresponding instructions of the apparatus for detecting correlated objects involved in an image can also be directly stored in the memory, which is not limited here.

The present disclosure provides a non-transitory computer-readable storage medium, the storage medium stores a computer program, and the computer program is configured to perform any method of detecting correlated objects involved in an image according to any of the above examples.

Those skilled in the art should understand that one or more examples of the present disclosure can be provided as a method, a system, or a computer program product. Therefore, one or more examples of the present disclosure can adopt the form of a complete hardware example, a complete software example, or an example combining software and hardware. Moreover, one or more examples of the present disclosure can be in a form of a computer program product having one or more computer-usable storage media (which can include but not limited to disk storage, CD-ROM, optical storage, etc.) containing computer-usable program codes.

In the present disclosure, “and/or” means having at least one of the two. For example, “A and/or B” can include three schemes: A, B, and “A and B”.

The various examples in the present disclosure are described in a progressive manner, and the same or similar parts between the various examples can be referred to each other, and each example focuses on the differences from other examples. In particular, as for the data processing device example, since it is basically similar to the method example, the description is relatively simple, and for related parts, reference can be made to the part of the description of the method example.

The above has described specific examples of the present disclosure. Other examples are within the scope of the appended claims. In some cases, the actions or steps described in the claims can be performed in a different order from that in the examples and still achieve desired results. In addition, the processes depicted in the drawings do not necessarily require the specific order or sequential order shown to achieve the desired result. In some examples, multitasking and parallel processing are also possible or can be advantageous.

The examples of the subject and functional operations described in the present disclosure can be implemented in the following: digital electronic circuits, tangible computer software or firmware, computer hardware that can include the structures disclosed in the present disclosure and their structural equivalents, or one or more of them. The examples of the subject matter described in the present disclosure can be implemented as one or more computer programs, that is, one or more units in the computer program instructions that are encoded in the tangible non-transitory program carrier to be executed by the data processing device or to control the operation of the data processing device. Alternatively or in addition, the program instructions can be encoded in artificially generated propagated signals, such as machine-generated electrical, optical, or electromagnetic signals, which are generated to encode information and transmit it to a suitable receiver device to be performed by the data processing device. The computer storage medium can be a machine-readable storage device, a machine-readable storage substrate, a random or serial access memory device, or a combination of one or more of them.

The processing and logic flows described in the present disclosure can be executed by one or more programmable computers executing one or more computer programs, to perform corresponding functions by operating according to input data and generating output. The processing and logic flow can also be executed by a dedicated logic circuit, such as FPGA (Field Programmable Gate Array) or ASIC (Application Specific Integrated Circuit), and the device can also be implemented as a dedicated logic circuit.

A computer suitable for executing a computer program can include, for example, a general-purpose and/or special-purpose microprocessor, or any other type of central processing unit. Generally, the central processing unit will receive instructions and data from a read-only memory and/or random access memory. The basic components of a computer can include a central processing unit for implementing or executing instructions and one or more memory devices for storing instructions and data. Generally, the computer will also include one or more mass storage devices for storing data, such as magnetic disks, magneto-optical disks, or optical disks, etc., or the computer will be operatively coupled with this mass storage device to receive data or send data to it, or both. However, the computer does not have to have such equipment. In addition, the computer can be embedded in another device, such as a mobile phone, a personal digital assistant (PDA), a mobile audio or video player, a game console, a global positioning system (GPS) receiver, or a universal serial bus (USB) flash drives are portable storage devices, to name a few.

Computer readable media suitable for storing computer program instructions and data can include all forms of non-transitory memory, media and memory devices, such as semiconductor memory devices (such as EPROMs, EEPROMs and flash memory devices), magnetic disks (such as internal hard disks or removable disks), magneto-optical disks, CD ROMs and DVD-ROM disks. The processor and the memory can be supplemented by or incorporated into a dedicated logic circuit.

Although the present disclosure contains many specific implementation details, these should not be construed as limiting any disclosed scope or claimed scope, but are mainly used to describe the features of specific disclosed examples. Certain features described in a plurality of examples in the present disclosure can also be implemented in combination in a single example. On the other hand, various features described in a single example can also be implemented in a plurality of examples separately or in any suitable sub-combination. In addition, although features can function in certain combinations as described above and even as originally claimed, one or more features from the claimed combination can in some cases be removed from the combination, and the claimed combination can refer to a sub-combination or a variant of the sub-combination.

Similarly, although operations are depicted in a specific order in the drawings, this should not be construed as requiring these operations to be performed in the specific order shown or sequentially, or requiring all illustrated operations to be performed to achieve the desired result. In some cases, multitasking and parallel processing can be advantageous. In addition, the separation of various system units and components in the examples should not be understood as requiring such separation in all examples, and it should be understood that the described program components and systems can usually be integrated in a single software product, or packaged into a plurality of software products.

Thus, specific examples of the subject matter have been described. Other examples are within the scope of the appended claims. In some cases, the actions recited in the claims can be performed in a different order and still achieve desired results. In addition, the processes depicted in the drawings are not necessarily in the specific order or sequential order shown in order to achieve the desired result. In some implementations, multitasking and parallel processing can be advantageous.

The above are only preferred examples of one or more examples of the present disclosure, and are not used to limit one or more examples of the present disclosure. Any modification, equivalent replacement, improvement within the spirit and principle of one or more examples of the present disclosure shall be included in the protection scope of one or more examples of the present disclosure.

1. A method of detecting correlated objects involved in an image, comprising:
detecting a face object, a hand object and a preset body part object involved in a target image, wherein the preset body part object represents a preset connection part between a face and a hand;
respectively predicting correlation between the detected face object and the detected preset body part object, and correlation between the detected preset body part object and the detected hand object, to obtain a first correlation prediction result between the face object and the preset body part object, and a second correlation prediction result between the preset body part object and the hand object; and
determining correlated objects involved in the target image based on the first correlation prediction result and the second correlation prediction result.

2. The method of claim 1, wherein
the method further comprises:
predicting correlation between the detected face object and the detected hand object to obtain a third correlation prediction result;
determining correlated objects involved in the target image based on the first correlation prediction result and the second correlation prediction result comprises:
adjusting the third correlation prediction result based on the first correlation prediction result and the second correlation prediction result; and
determining correlated objects involved in the target image based on the adjusted third correlation prediction result.

3. The method of claim 2, wherein
the target image involves a plurality of face objects and a plurality of hand objects; and
predicting correlation between the detected face object and the detected hand object to obtain the third correlation prediction result comprises:
combining each of the detected face objects with each of the detected hand objects to form a plurality of first combinations;
obtaining a third correlation prediction result between the face object and the hand object in each of the first combinations by, for each of the first combinations; and
predicting correlation between the face object and the hand object in the first combination based on visual features and position features of the face object and the hand object in the first combination.

4. The method of claim 1, wherein
the target image involves a plurality of preset body part objects; and
respectively predicting correlation between the detected face object and the detected preset body part object, and correlation between the detected preset body part object and the detected hand object, to obtain the first correlation prediction result between the face object and the preset body part object, and the second correlation prediction result between the preset body part object and the hand object comprises:
combining each of the detected face objects with each of the preset body part objects to form a plurality of second combinations;
obtaining a first correlation prediction result between the face object and the preset body part object in each of the second combinations by, for each of the second combinations, predicting correlation on the face object and the preset body part object in the second combination based on visual features and position features of the face object and the preset body part object in the second combination;
combining each of the detected preset body part objects with each of the hand objects to form a plurality of third combinations; and
obtaining a second correlation prediction result between the preset body part object and the hand object in each of the third combinations by, for each of the third combinations, predicting correlation between the preset body part object and the hand object in the third combination based on visual features and position features of the preset body part object and the hand object in the third combination.

5. The method of claim 2, wherein adjusting the third correlation prediction result based on the first correlation prediction result and the second correlation prediction result comprises:
determining a target face object of which a first correlation prediction score in the first correlation prediction result with respect to the preset body part object is highest;
determining a target hand object of which a second correlation prediction score in the second correlation predication result with respect to the preset body part object is highest; and
based on the first correlation prediction score of the target face object with respect to the preset body part object, and the second correlation prediction score of the target hand object with respect to the preset body part object, adjusting a third correlation prediction score in the third correlation prediction result between the target face object and the target hand object.

6. The method of claim 5, wherein
determining the target face object of which a first correlation prediction score in the first correlation prediction result with respect to the preset body part object is highest comprises at least one of:
determining candidate face objects, wherein each of the candidate face objects has a first correlation prediction score with respect to the preset body part object greater than a preset threshold; and
selecting one from the candidate face objects of which the first correlation prediction score with respect to the preset body part object is highest as the target face object; or
determining the target hand object of which a second correlation prediction score in the second correlation predication result with respect to the preset body part object is highest comprises:
determining candidate hand objects, wherein each of the candidate hand objects has a second correlation prediction score with respect to the preset body part object greater than a preset threshold; and
selecting one from the candidate hand objects of which the second correlation prediction score with respect to the preset body part object is highest as the target hand object.

7. The method of claim 5, wherein based on the first correlation prediction score of the target face object with respect to the preset body part object, and the second correlation prediction score of the target hand object with respect to the preset body part object, adjusting the third correlation prediction score in the third correlation prediction result between the target face object and the target hand object comprises:
determining an average value of the first correlation prediction score of the target face object with respect to the preset body part object, and the second correlation prediction score of the target hand object with respect to the preset body part object; and
obtaining the adjusted third correlation prediction score by adding the average value to the third correlation prediction score between the target face object and the target hand object.

8. The method of claim 7, wherein determining correlated objects involved in the target image based on the adjusted third correlation prediction result comprises:
selecting each from a plurality of the third correlation prediction scores in an order of the third correlation prediction scores from high to low, and
for a current combination of the face object and the hand object corresponding to the selected third correlation prediction score:
based on determined correlated objects involved in the target image, determining a number of hand objects that are correlated with the face object in the current combination as a first number, and determining a number of face objects that are correlated with the hand object in the current combination as a second number; and
in response to that the first number is lower than a first preset threshold, and the second number is lower than a second preset threshold, determining the face object and the hand object in the current combination as correlated objects involved in the target image.

9. The method of claim 1, wherein determining correlated objects involved in the target image based on the first correlation prediction result and the second correlation prediction result comprises:
based on the first correlation prediction result and the second correlation prediction result, determining a face object and a hand object of which correlations with respect to a same preset body part object satisfying a preset condition as correlated objects involved in the target image.

10. The method of claim 1, further comprising:
outputting a detection result of the correlated objects involved in the target image.

11. The method of claim 1, wherein the preset body part object comprises at least one of a shoulder object, an elbow object and a wrist object.

12. The method of claim 2, wherein
the face object, the hand object, and the preset body part object involved in the target image are detected from the target image by a target object detecting network;
the third correlation prediction result is detected by a first preset network comprising a face-hand correlation detecting model;
the first correlation prediction result and the second correlation prediction result are detected by a second preset network comprising a face-preset-body-part correlation detecting model and a preset-body-part-hand correlation detecting model; and
the target object detecting network, the face-hand correlation detecting model, the face-preset-body-part correlation detecting model and the preset-body-part-hand correlation detecting model are trained by:
training the target object detecting network based on a first training sample set which comprises a plurality of training samples with respective first label information, wherein the first label information contains respective position label information of face objects, hand objects and preset body part objects; and
jointly training the target object detecting network, the face-hand correlation detecting model, the face-preset-body-part correlation detecting model, and the preset-body-part-hand correlation detecting model based on a second training sample set which comprises a plurality of training samples with respective second label information, wherein the second label information contains respective position label information of face objects, hand objects and preset body part objects, and respective label information on correlations between face objects, preset body part objects and hand objects.

13. An electronic device comprising:
at least one processor; and
one or more memories coupled to the at least one processor and storing programming instructions for execution by the at least one processor to perform operations for detecting correlated objects involved in an image, the operations comprising:
detecting a face object, a hand object and a preset body part object involved in a target image, wherein the preset body part object represents a preset connection part between a face and a hand;
respectively predicting correlation between the detected face object and the detected preset body part object, and correlation between the detected preset body part object and the detected hand object, to obtain a first correlation prediction result between the face object and the preset body part object, and a second correlation prediction result between the preset body part object and the hand object; and
determining correlated objects involved in the target image based on the first correlation prediction result and the second correlation prediction result.

14. The electronic device according to claim 13, wherein the operations further comprise:
predicting correlation between the detected face object and the detected hand object to obtain a third correlation prediction result;
determining correlated objects involved in the target image based on the first correlation prediction result and the second correlation prediction result comprises:
adjusting the third correlation prediction result based on the first correlation prediction result and the second correlation prediction result; and
determining correlated objects involved in the target image based on the adjusted third correlation prediction result.

15. The electronic device according to claim 14, wherein the target image involves a plurality of face objects and a plurality of hand objects; and
predicting correlation between the detected face object and the detected hand object to obtain the third correlation prediction result comprises:
combining each of the detected face objects with each of the detected hand objects to form a plurality of first combinations;
obtaining a third correlation prediction result between the face object and the hand object in each of the first combinations by, for each of the first combinations; and
predicting correlation between the face object and the hand object in the first combination based on visual features and position features of the face object and the hand object in the first combination.

16. The electronic device according to claim 13, the target image involves a plurality of preset body part objects; and
respectively predicting correlation between the detected face object and the detected preset body part object, and correlation between the detected preset body part object and the detected hand object, to obtain the first correlation prediction result between the face object and the preset body part object, and the second correlation prediction result between the preset body part object and the hand object comprises:
combining each of the detected face objects with each of the preset body part objects to form a plurality of second combinations;
obtaining a first correlation prediction result between the face object and the preset body part object in each of the second combinations by, for each of the second combinations, predicting correlation on the face object and the preset body part object in the second combination based on visual features and position features of the face object and the preset body part object in the second combination;
combining each of the detected preset body part objects with each of the hand objects to form a plurality of third combinations; and
obtaining a second correlation prediction result between the preset body part object and the hand object in each of the third combinations by, for each of the third combinations, predicting correlation between the preset body part object and the hand object in the third combination based on visual features and position features of the preset body part object and the hand object in the third combination.

17. The electronic device according to claim 14, wherein adjusting the third correlation prediction result based on the first correlation prediction result and the second correlation prediction result comprises:
determining a target face object of which a first correlation prediction score in the first correlation prediction result with respect to the preset body part object is highest;
determining a target hand object of which a second correlation prediction score in the second correlation predication result with respect to the preset body part object is highest; and
based on the first correlation prediction score of the target face object with respect to the preset body part object, and the second correlation prediction score of the target hand object with respect to the preset body part object, adjusting a third correlation prediction score in the third correlation prediction result between the target face object and the target hand object.

18. The electronic device according to claim 17, wherein
determining the target face object of which a first correlation prediction score in the first correlation prediction result with respect to the preset body part object is highest comprises at least one of:
determining candidate face objects, wherein each of the candidate face objects has a first correlation prediction score with respect to the preset body part object greater than a preset threshold; and
selecting one from the candidate face objects of which the first correlation prediction score with respect to the preset body part object is highest as the target face object; or
determining the target hand object of which a second correlation prediction score in the second correlation predication result with respect to the preset body part object is highest comprises:
determining candidate hand objects, wherein each of the candidate hand objects has a second correlation prediction score with respect to the preset body part object greater than a preset threshold; and
selecting one from the candidate hand objects of which the second correlation prediction score with respect to the preset body part object is highest as the target hand object.

19. The electronic device according to claim 17, wherein based on the first correlation prediction score of the target face object with respect to the preset body part object, and the second correlation prediction score of the target hand object with respect to the preset body part object, adjusting the third correlation prediction score in the third correlation prediction result between the target face object and the target hand object comprises:
determining an average value of the first correlation prediction score of the target face object with respect to the preset body part object, and the second correlation prediction score of the target hand object with respect to the preset body part object; and
obtaining the adjusted third correlation prediction score by adding the average value to the third correlation prediction score between the target face object and the target hand object.

20. A non-transitory computer-readable storage medium coupled to the at least one processor and storing programming instructions for execution by the at least one processor, wherein the programming instructions instruct the at least one processor to perform operations for detecting correlated objects involved in an image, the operations comprising:
detecting a face object, a hand object and a preset body part object involved in a target image, wherein the preset body part object represents a preset connection part between a face and a hand;
respectively predicting correlation between the detected face object and the detected preset body part object, and correlation between the detected preset body part object and the detected hand object, to obtain a first correlation prediction result between the face object and the preset body part object, and a second correlation prediction result between the preset body part object and the hand object; and
determining correlated objects involved in the target image based on the first correlation prediction result and the second correlation prediction result.
